(19) United States
(12) Patent Application Publication
(10) Pub. No.: US 2025/0260464 A1
(43) Pub. Date: Aug. 14, 2025

(54) HANDLING OF SENSING-COMMUNICATION CONFLICTION IN INTEGRATED SENSING AND COMMUNICATION SYSTEM

(71) Applicant: QUALCOMM Incorporated, San Diego, CA (US)

(72) Inventors: Min HUANG, Beijing (CN); Jing DAI, Beijing (CN); Mingxi YIN, Beijing (CN); Chao WEI, Beijing (CN); Hao XU, Beijing (CN); Danlu ZHANG, San Diego, CA (US)

(21) Appl. No.: 18/992,134

(22) PCT Filed: Sep. 10, 2022
(86) PCT No.: PCT/CN2022/118281

§ 371 Date: Jan. 7, 2025

(51) Int. Cl. H04B 7/06

(52) U.S. Cl. CPC H04B 7/0695

(57) ABSTRACT

Aspects presented herein may improve the performance of ISAC systems by enabling one or more wireless devices to handle sensing-communication confliction in ISAC systems. In one aspect, a first apparatus transmits, to a second apparatus, a first phase continuity reset indication after determining to change a transmission beam for a periodic sensing signal from a first beam to a second beam, the first beam being different than the second beam. The first apparatus transmits, to the second apparatus, a second phase continuity reset indication after determining to change the transmission beam for the periodic sensing signal from the second beam back to the first beam.

### TECHNICAL FIELD

The present disclosure relates generally to communication systems, and more particularly, to positioning systems involving radio frequency (RF) sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a second apparatus, a first phase continuity reset indication after determining to change a transmission beam for a periodic sensing signal from a first beam to a second beam, the first beam being different than the second beam. The apparatus transmits, to the second apparatus, a second phase continuity reset indication after determining to change the transmission beam for the periodic sensing signal from the second beam back to the first beam.

In an aspect of the disclosure, a method, a computer-readable medium, and an apparatus are provided. The apparatus receives, from a first apparatus, a first phase continuity reset indication indicating a change of a transmission beam for a periodic sensing signal from a first beam to a second beam, the first beam being different than the second beam. The apparatus receives, from the first apparatus, a second phase continuity reset indication indicating a change of the transmission beam for the periodic sensing signal from the second beam back to the first beam.

In an aspect of the disclosure, a method, a computer-readable medium, and an apparatus are provided. The apparatus transmits, to a second apparatus, a sensing signal periodically. The apparatus transmits, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted.

In an aspect of the disclosure, a method, a computer-readable medium, and an apparatus are provided. The apparatus receives, from a first apparatus, a sensing signal periodically. The apparatus receives, from the first apparatus, a sensing signal cancelation indication, the sensing signal cancelation indication indicating a number of occasions that the sensing signal will not be transmitted from the first apparatus or was not transmitted by the first apparatus.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of radar signals (e.g., radar reference signals (RRSs)) generated from a wireless device in accordance with various aspects of the present disclosure.

FIG. 6 is a diagram illustrating an example of shared components for integrated sensing and communication (ISAC) in accordance with various aspects of the present disclosure.

FIG. 7A is a diagram illustrating an example co-located and cooperative radar and communication system in accordance with various aspects of the present disclosure.

FIG. 7B is a diagram illustrating an example co-design of communication and radar system in accordance with various aspects of the present disclosure.

FIG. 8A is a diagram illustrating an example mono-static sensing mode in accordance with various aspects of the present disclosure.

FIG. 8B is a diagram illustrating an example bi-static/multi-static sensing mode in accordance with various aspects of the present disclosure.

FIG. 9 is a diagram illustrating an example ISAC between a base station and two UEs in accordance with various aspects of the present disclosure.

FIG. 10 is a communication flow illustrating an example of informing a sensing device regarding phase continuity interruption during a bi-static/multi-static sensing operation in accordance with various aspects of the present disclosure.

FIG. 11 is a communication flow illustrating an example of informing a sensing device regarding sensing signal cancellation during a bi-static/multi-static sensing operation in accordance with various aspects of the present disclosure.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a diagram illustrating an example of a hardware implementation for an example apparatus and/or network entity.

FIG. 16 is a flowchart of a method of wireless communication.

FIG. 17 is a diagram illustrating an example of a hardware implementation for an example apparatus and/or network entity.

FIG. 18 is a flowchart of a method of wireless communication.

FIG. 19 is a diagram illustrating an example of a hardware implementation for an example apparatus and/or network entity.

### DETAILED DESCRIPTION

Aspects presented herein may improve the performance of ISAC systems. Aspects presented herein may enable one or more wireless devices to handle sensing-communication confliction in ISAC systems. For example, in one aspect of the present disclosure, a sensing device (e.g., a base station, a component of a base station, a sensing UE, etc.) may be informed (or made aware) of potential interruption in Doppler frequency measurement during a sensing operation, such that the sensing device may reset its Doppler frequency measurement. In another aspect of the present disclosure, the sensing device may be informed (or made aware) of cancellation in sensing signals during a sensing operation, such as when a set of sensing signals is being preempted by communication signals (e.g., URLLC communication signals or signals with higher transmission priorities). Then, the sensing device may stop the sensing operation or remove the invalid sensing result to maintain the accuracy of the sensing operation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

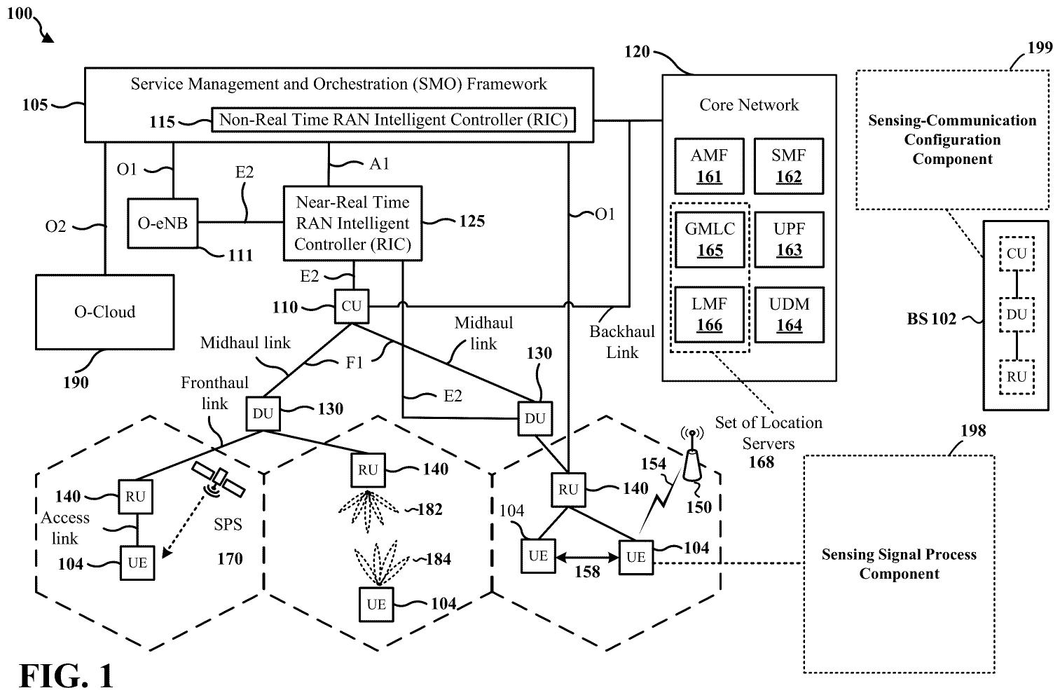

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, In certain aspects, the base station 102 may be configured to transmit, to a second apparatus, a first phase continuity reset indication after determining to change a transmission beam for a periodic sensing signal from a first beam to a second beam, the first beam being different than the second beam; and transmit, to the second apparatus, a second phase continuity reset indication after determining to change the transmission beam for the periodic sensing signal from the second beam back to the first beam via the sensing-communication configuration component 199. In certain aspects, the base station 102 may be configured to transmit, to a second apparatus, a sensing signal periodically; and transmit, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted via the sensing-communication configuration component 199. In certain aspects, the UE 104 may be configured to receive, from a first apparatus, a first phase continuity reset indication indicating a change of a transmission beam for a periodic sensing signal from a first beam to a second beam, the first beam being different than the second beam; and receive, from the first apparatus, a second phase continuity reset indication indicating a change of the transmission beam for the periodic sensing signal from the second beam back to the first beam via the sensing signal process component 198. In certain aspects, the UE 104 may be configured to receive, from a first apparatus, a sensing signal periodically; and receive, from the first apparatus, a sensing signal cancelation indication, the sensing signal cancelation indication indicating a number of occasions that the sensing signal will not be transmitted from the first apparatus or was not transmitted by the first apparatus via the sensing signal process component 198.

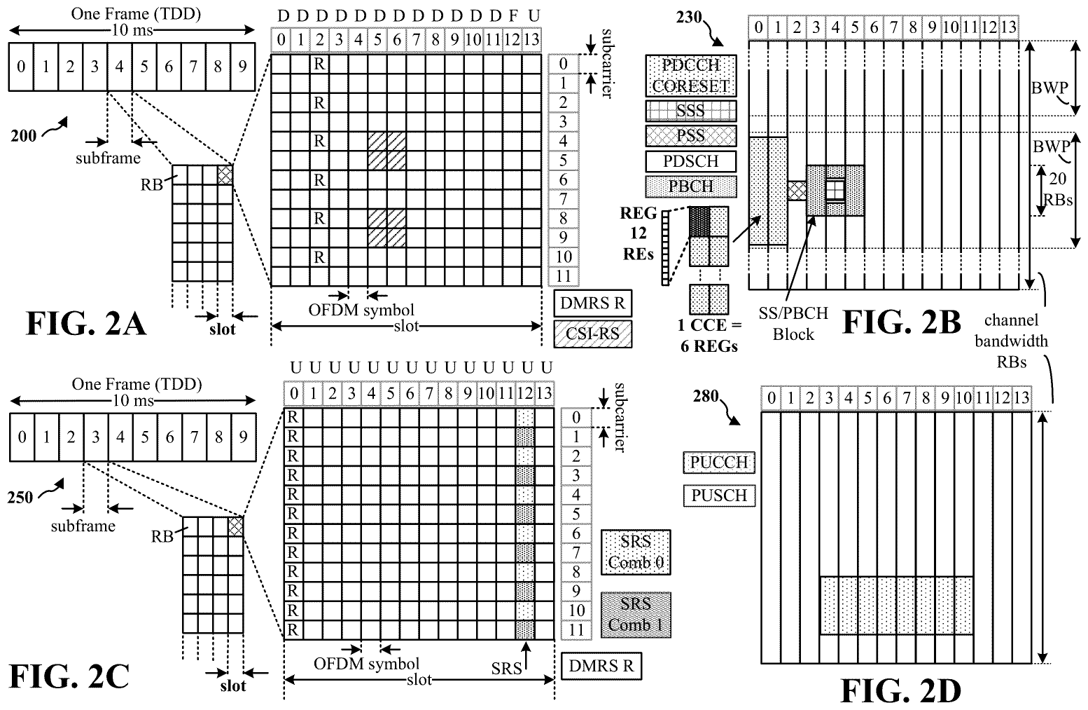

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

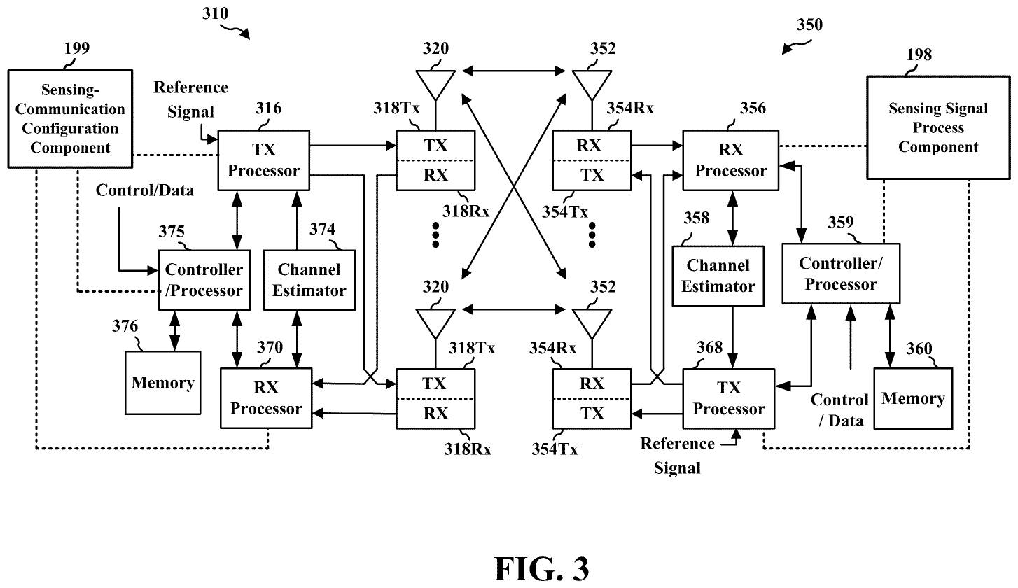

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing signal process component 198 of FIG. 1.

At least one of the TX processor 316, the RX processor 370, and the controller/processor 375 may be configured to perform aspects in connection with the sensing-communication configuration component 199 of FIG. 1.

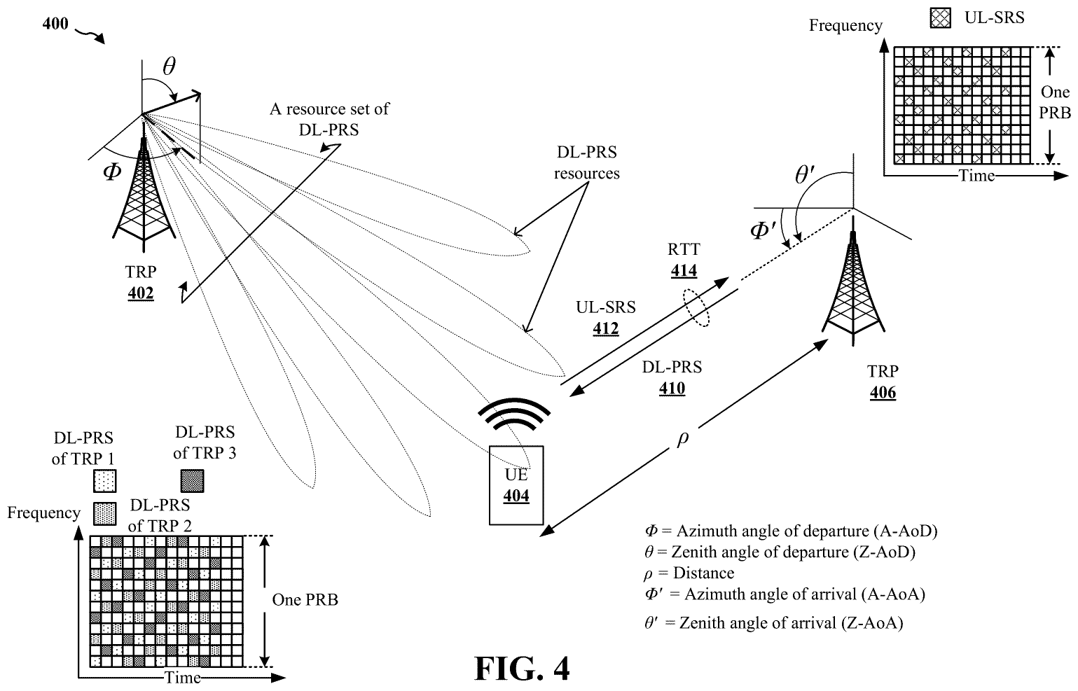

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a base station, a component of the base station, a UE, etc.) may also be configured to include radar capabilities, which may be referred to as “radio frequency (RF) sensing” and/or “cellular-based RF sensing.” For example, a wireless device may transmit radar reference signals (RRSs) and measure the RRSs reflected from one or more objects. Based at least in part on the measurement, the wireless device may determine or estimate a distance between the wireless device and the one or more objects. In another example, a first wireless device may also receive RRSs transmitted from a second wireless device, where the first wireless device may determine or estimate a distance between the first wireless device and the second wireless device based at least in part on the received RRS. As such, in some examples, RF sensing techniques may be used for UE positioning and/or for assisting UE positioning. For purposes of the present disclosure, a device that is capable of performing RF sensing (e.g., transmitting and/or receiving RRS for detecting an object or for estimating the distance between the device and the object) may be referred to as an “RF sensing node.” For example, an RF sensing node may be a UE, a base station, a component of the base station, a TRP, a device capable of transmitting RRS, and/or a device configured to perform radar functions, etc.

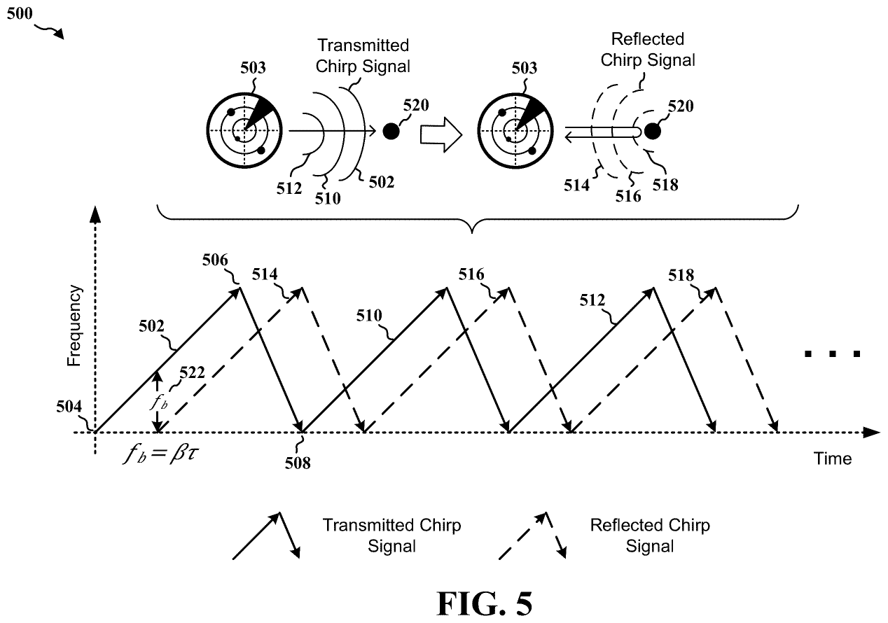

FIG. 5 is a diagram 500 illustrating an example radar signal (e.g., RRS) generated from an RF sensing node in accordance with various aspects of the present disclosure. An RF sensing node 503 may detect an object 520 (e.g., the location, the distance, and/or the speed of the object 520 with respect to the RF sensing node 503) by transmitting RRS towards the object 520 and receiving the RRS reflected (e.g., bounce off) from the object 520. In some examples, the object 520 may be a radar receiver or have a capability to receive and process RRS.

In one example, the RRS may be a chirp signal that includes a frequency that varies linearly (e.g., has a frequency sweeping) over a fixed period of time (e.g., over a sweep time) by a modulating signal. For example, as shown by the diagram 500, a transmitted chirp signal 502 may have a starting frequency at 504 of a sinusoid. Then, the frequency may gradually (e.g., linearly) increase on the sinusoid until it reaches an ending (or highest) frequency at 506 of the sinusoid, and then the frequency of the signal may return to the starting frequency as shown at 508 and another chirp signal 510 may be transmitted in the same way. In other words, each chirp signal may include an increase in frequency (e.g., linearly) and a drop in frequency or vice versa (e.g., including a decrease in frequency and then an increase in frequency), such that the RF sensing node 503 may transmit chirp signals sweeping in frequency. In some examples, such chirp signal may also be referred to as a frequency modulated continuous wave (FMCW).

After a chirp signal (e.g., chirp signal 502, 510, 512, etc.) is transmitted by the RF sensing node 503, the transmitted chirp signal may reach the object 520 and reflect back to the RF sensing node 503, such as shown by the reflected chirp signals 514, 516, and 518, which may correspond to the transmitted chirp signals 502, 510, and 512, respectively. As there may be a distance between the RF sensing node 503 and the object 520 and/or it may take time for a transmitted chirp signal to reach the object 520 and reflect back to the RF sensing node 503, a delay may exist between a transmitted chirp signal and its corresponding reflected chirp signal. As the delay may be proportional to a range between the RF sensing node 503 and the object 520 (e.g., the further the target, the larger the delay and vice versa), the RF sensing node 503 may be able to measure or estimate a distance between the RF sensing node 503 and the object 520 based on the delay.

In some examples, the RF sensing node 503 may also measure a difference in frequency between the transmitted chirp signal and the reflected chirp signal, which may also be proportional to the distance between the RF sensing node 503 and the object 520. In other words, as the frequency difference between the reflected chirp signal and the transmitted chirp signal increases with the delay, and the delay is linearly proportional to the range, the distance of the object 520 from the RF sensing node 503 may also be determined based on the difference in frequency. Thus, the reflected chirp signal from the object 520 may be mixed with the transmitted chirp signal and down-converted to produce a beat signal (f_{b}) which may be linearly proportional to the range after demodulation. For example, the RF sensing node 503 may determine a beat signal 522 by mixing the transmitted chirp signal 502 and its corresponding reflected chirp signal 514. While examples in the diagram illustrate using an FMCW waveform for the RRS, other types of radar waveforms may also be used by the RF sensing node 503 for the RRS.

Due to an increased amount of bandwidth (BW) being allocated for cellular communications systems (e.g., 5G and beyond) and an increased amount of applications (e.g., use cases) being introduced with cellular communications systems, joint communication and RF sensing, which may also be referred to as integrated sensing and communication (ISAC) and/or joint communication-radar (JCR), may become an important feature for cellular systems. For example, a wireless device (e.g., a base station, a component of a base station, a UE, a component of a UE, an RF sensing node, etc.) may be configured to transmit communication signals (e.g., PDSCH, PUSCH, PSSCH, etc.) with radar signals (e.g., RRS, FMCW signals, etc.) together or close in time (e.g., based on TDM, FDM, SDM, etc.). In addition, OFDM waveform (or its variants) may be used as the waveform for the ISAC/JCR as the OFDM waveform may enable in-band multiplexing with other cellular reference signals and physical channels. As such, the radar signals may be multiplexed with communication signals based on OFDM waveform. For purposes of the present disclosure, a wireless device that performs an RF sensing based on OFDM waveform(s) or transmits RRS based on OFDM waveform(s) may be referred to as an “OFDM radar.”

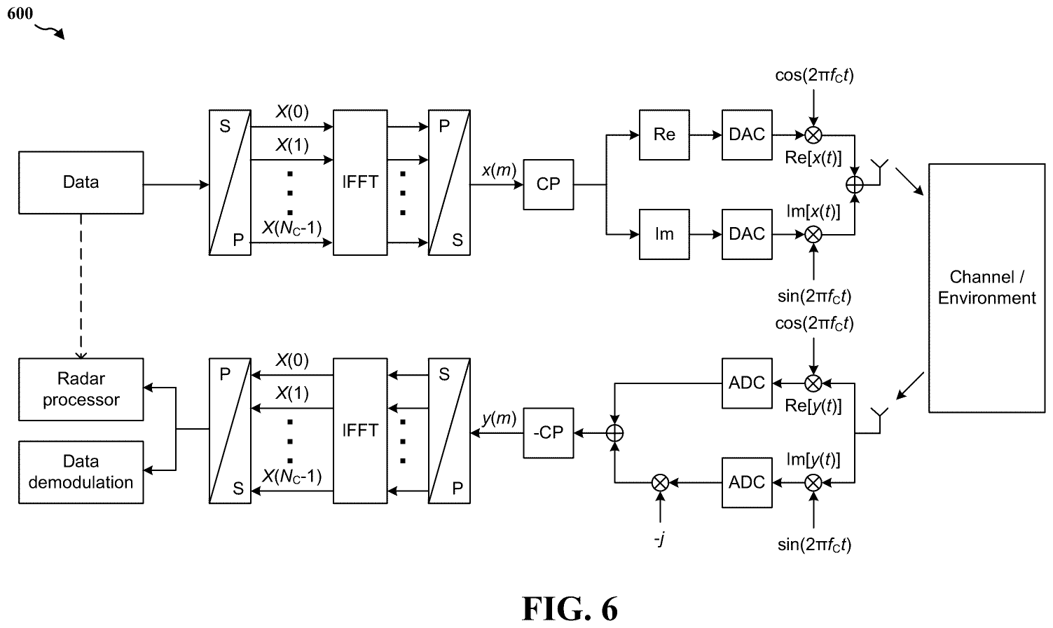

FIG. 6 is a diagram 600 illustrating an example of shared components for ISAC in accordance with various aspects of the present disclosure. A wireless device may be configured to share its RF (and possibly baseband) hardware components and frequency band for both sensing and communication to provide a cost and spectrum effective design. In some examples, ISAC may be used for macro sensing, such as meteorological monitoring, autonomous driving, dynamic map, low-altitude airspace (e.g., unmanned aerial vehicle (UAV)) management, and intruder detection, etc. In other examples, ISAC may be used for micro sensing, such as gesture recognition, vital signal detection, and high-resolution imaging with THz, etc. In addition, ISAC may also provide sensing assisted communication, where information obtained via sensing (e.g., whether there are obstacles in certain directions) may be used for improving the communication, such as for beam management.

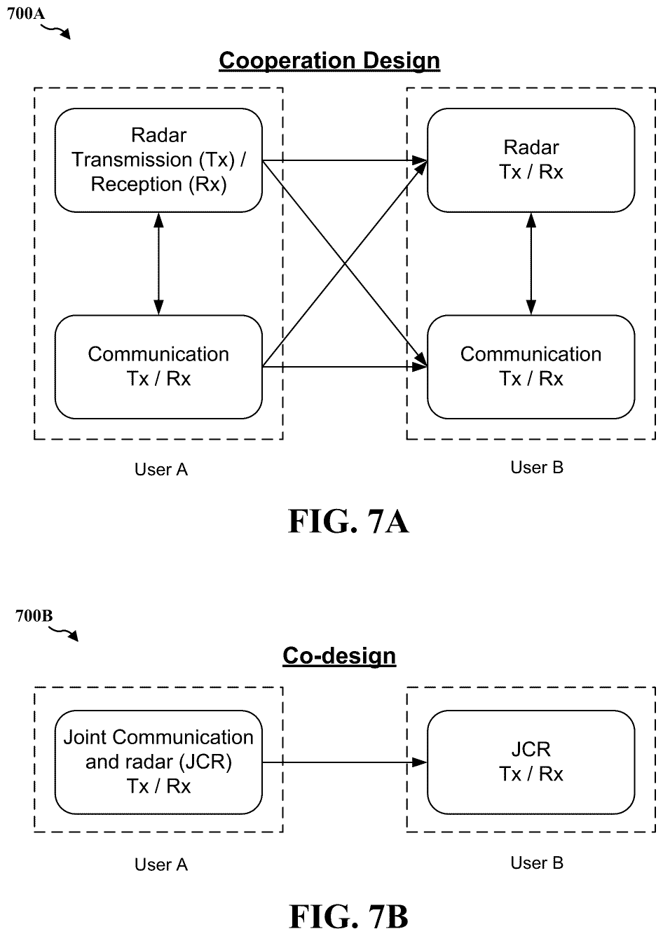

In some implementations, ISAC systems may be categorized as co-located and cooperative radar and communication systems and co-design of communication and radar systems. FIG. 7A is a diagram 700A illustrating an example co-located and cooperative radar and communication system in accordance with various aspects of the present disclosure. For this type of ISAC system, some knowledge (e.g., transmission information/configuration) is shared between the communication aspect and radar aspect of the system to improve the system's performance, without much altering the core operation of the radar and communication system. For example, as shown by the diagram 700A, each of the devices used by a first user (user A) and a second user (user B) may include a radar transmission (Tx)/reception (Rx) component that is capable of transmitting/receiving radar reference signals (RRSs) and a communication Tx/Rx component that is capable of transmitting/receiving communication signals. The radar Tx/Rx component and the communication Tx/Rx component may communicate with each to coordinate the transmission of radar signals and communication signals to other devices and/or the reception of radar signals and communication signals from other devices.

FIG. 7B is a diagram 700B illustrating an example co-design of communication and radar system in accordance with various aspects of the present disclosure. For this type of ISAC system, as shown by the diagram 700B, a common transmitter or receiver is used for both communication and radar functionalities. This type of system may specify certain amount of modifications in the transmitting waveform generation or the receiver processing of both or either of the radar and communication systems. This type of ISAC system design may provide an improved hardware and spectrum reuse. Communication-centric ISAC that exploits a single communication transmission hardware may be favored by some network implementation because it may support both high-data rate communication and high-resolution sensing. For example, as described above, OFDM-based waveform may be used by the radar system for sensing purpose while remaining compatible with OFDM-based communication system.

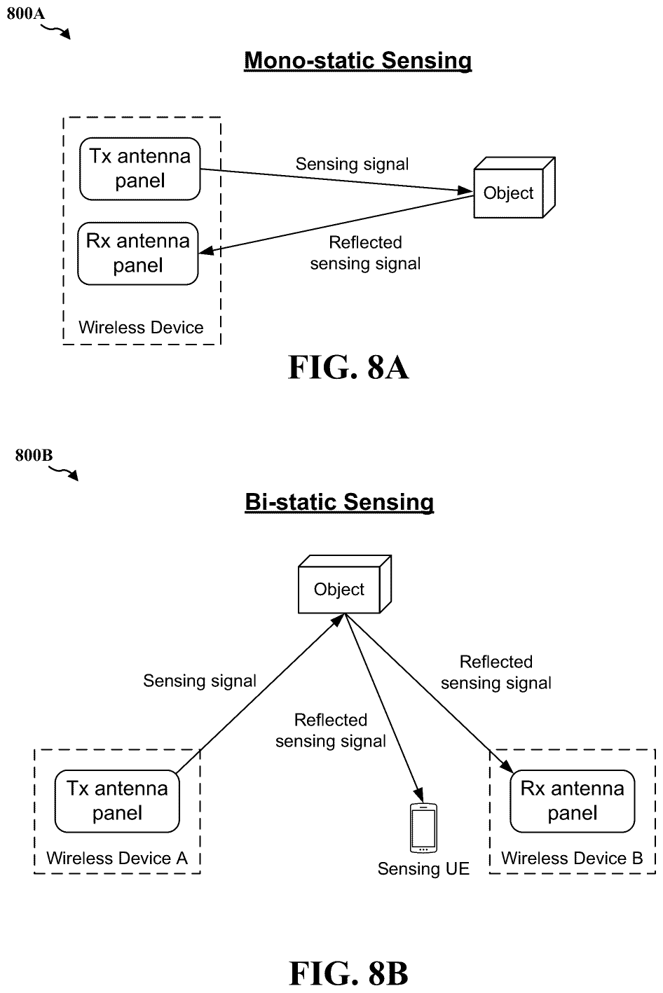

In some implantations, RF sensing may be categorized in two types of RF sensing mode: a mono-static sensing mode and a bi-static/multi-static sensing mode (which may also be referred to as “mono-static RF sensing” and “bi-static RF sensing” respectively). FIG. 8A is a diagram 800A illustrating an example mono-static sensing mode in accordance with various aspects of the present disclosure. Under mono-static sensing, the transmitter (e.g., the Tx antenna panel) and the receiver (e.g., the Rx antenna panel) of the RF sensor are co-located, such as in the same wireless device (e.g., a base station, a component of a base station, a UE, a component of a UE, etc.). Thus, the transmission and reception of the radar signals may be performed by one device. In other words, one radar/sensor is configured to both transmit sensing signals and receive reflected sensing signals. An advantage of mono-static sensing is that it may not specify Tx/Rx (transmitter/receiver) pairing/grouping. However, mono-static sensing may specify self-interference mitigation as the same wireless device is used for transmitting both sensing signals and communication signals.

FIG. 8B is a diagram 800B illustrating an example bi-static/multi-static sensing mode in accordance with various aspects of the present disclosure. Under bi-static/multi-static sensing, the transmitter and receiver may be separated (e.g., on different wireless devices and/or locations). For example, the transmitter (e.g., the Tx antenna panel) of a first wireless device may transmit sensing signals, and the sensing signals or sensing signals reflected from one or more objects may be received by the receiver (e.g., the Rx antenna panel) of a second wireless device (e.g., a sensing base station, a sensing UE, etc.). An advantage of bi-static/multi-static sensing is that it may not specify self-interference mitigation. However, bi-static/multi-static sensing may specify Tx/Rx (transmitter/receiver) pairing/grouping. However, mono-static sensing may specify self-interference mitigation as the same wireless device is used for transmitting both sensing signals and communication signals.

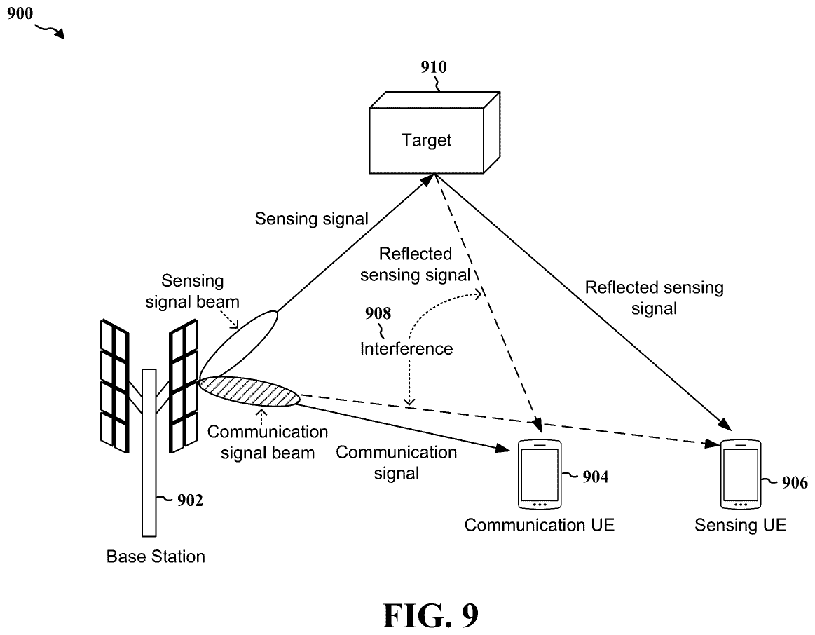

FIG. 9 is a diagram 900 illustrating an example ISAC between a base station and two UEs in accordance with various aspects of the present disclosure. For purposes of the present disclosure, a UE that is communicating with another wireless device, such as receiving communication signals from a base station or another UE, may be referred to as a “communication UE,” whereas a UE that is performing RF sensing, such as receiving sensing signals from another wireless device, may be referred to as a “sensing UE.” While the example shows a base station is communicating with two UEs, it is merely for illustration purposes. Aspects presented herein may also be applied to transmissions from a UE to other wireless devices (e.g., a base station and a second UE, etc.)

In some scenarios, in bi-static sensing (e.g., base station-UE bi-static sensing), during the Doppler measurement by multiple occasions of periodic sensing signals, in some time occasions, the sensing signals may conflict with higher-priority communication (e.g., URLLC) signals. For example, a base station 902 may transmit communication signals to a communication UE 904 (e.g., via a communication signal beam) and sensing signals to a sensing UE 906 (e.g., via a sensing signal beam) concurrently or close in time. As shown at 908, the sensing signals or the reflected sensing signals may cause interference for the reception of the communication signals at the communication UE 904, and/or the communication signals may cause interference for the sensing operation at the sensing UE 906.

In one example, due to small communication data payload (e.g., there are sufficient resources to transmit both a communication signal and a sensing signal in a transmission occasion) or non-co-location of communication UE 904 and a sensing target 910, the base station 902 may transmit the sensing signal and the communication signal based on FDM (e.g., using same Tx beam but different frequency bands) and/or based on SDM (e.g., using different Tx beams). On the other hand, due to large communication data payload (e.g., there are insufficient resources to transmit both a communication signal and a sensing signal in a transmission occasion) and co-location of the communication UE 904 and the sensing target 910, the base station 902 may not be able to transmit the sensing signal and the communication signal based on FDM and/or SDM.

In some examples, while the sensing UE 906 is performing Doppler frequency measurement to maintain the phase continuity, interference generated from the communication signals may affect the Doppler frequency measurement. For example, when the base station 902 is able to transmit the sensing signals and the communication signals concurrently (e.g., based on FDM), if the Tx beam for transmitting the sensing signal is changed due to the communication signal transmission, Doppler frequency measurement by the sensing UE 906 may not be able to continue. Thus, the Doppler estimation performed by the sensing UE 906 may be specified/configured to restart. In other words, to keep phase continuity during Doppler frequency measurement, Tx beam of sensing signal at the base station 902 may be specified to be retained.

Aspects presented herein may improve the performance of ISAC systems. Aspects presented herein may enable one or more wireless devices to handle sensing-communication confliction in ISAC systems. For example, in one aspect of the present disclosure, a sensing device (e.g., a base station, a component of a base station, a sensing UE, etc.) may be informed (or made aware) of potential interruption in Doppler frequency measurement during a sensing operation, such that the sensing device may reset its Doppler frequency measurement. In another aspect of the present disclosure, the sensing device may be informed (or made aware) of cancellation in sensing signals during a sensing operation, such as when a set of sensing signals is being preempted by communication signals (e.g., URLLC communication signals or signals with higher transmission priorities). Then, the sensing device may stop the sensing operation or remove the invalid sensing result to maintain the accuracy of the sensing operation.

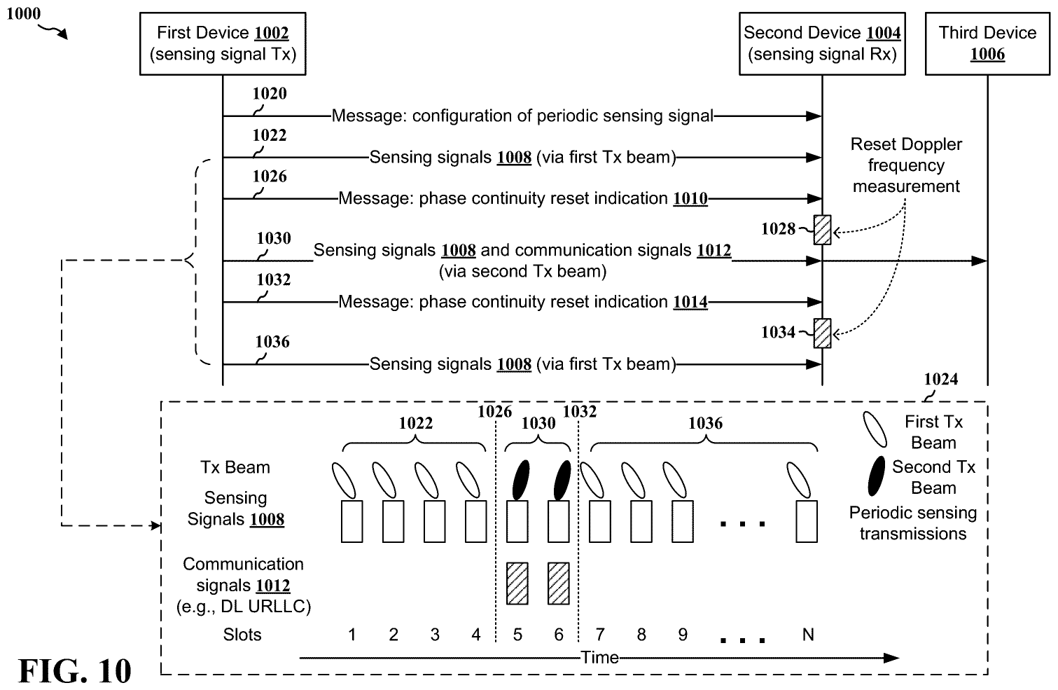

FIG. 10 is a communication flow 1000 illustrating an example of informing a sensing device regarding phase continuity interruption during a bi-static/multi-static sensing operation in accordance with various aspects of the present disclosure. The numberings associated with the communication flow 1000 do not specify a particular temporal order and are merely used as references for the communication flow 1000. Aspects presented herein may enable a first device, such as a first base station, to transmit phase continuity reset indication(s) to a second device (e.g., a second base station or a sensing UE). Then, upon receiving the phase continuity reset indication(s), the wireless device may reset its Doppler frequency measurement to maintain the accuracy of Doppler estimation.

At 1020, a first device 1002 (or a first apparatus or an antenna panel) may configure a second device 1004 to receive sensing signals 1008 periodically from the first device 1002. In one example, the first device 1002 may be a base station or a component of a base station, and the second device 1004 may be a UE, another base station or a component of another base station, etc. The sensing signals may be based on FMCW signals, such as described in connection with FIG. 5.

At 1022, after configuring the second device 1004 to receive the sensing signals 1008, the first device 1022 may transmit sensing signals 1008 for reception by the second device 1004 (or towards a target and for reception by the second device 1004) via a first transmission (Tx) beam. For example, as shown at 1024, the first device 1002 may transmit sensing signals 1008 periodically from a first slot (slot 1) to an N^{th} slot (slot N).

During transmission of the sensing signals 1008, the first device 1002 may be configured or scheduled to transmit a set of communication signals 1012 (e.g., URLLC signals or signals with higher priorities), such as to a third device 1006 or to the second device 1004. For example, as shown at 1026, the first device 1002 may be scheduled to transmit communication signals 1012 at slots 5 and 6 via a second Tx beam.

At 1026, if the first device 1002 determines that the transmission phase continuity may be broken and that the communication signals 1012 may be transmitted concurrently with the sensing signals 1008 (e.g., based on FDM and/or based on SDM if there are multiple antenna panels), such as via the second Tx beam, the first device 1002 may transmit a phase continuity reset indication 1010 (e.g., a first phase continuity reset indication) to the second device 1004 to inform the second device 1004 regarding a potential/possible phase continuity interruption. In response, at 1028, the second device 1004 may reset its Doppler frequency measurement after receiving the phase continuity reset indication 1010.

At 1030, the first device 1002 may transmit the sensing signals 1008 and the communication signals 1012 concurrently via the second Tx beam for reception by the second device 1004 and/or the third device 1006. The transmission of the sensing signals 1008 and the communication signals 1012 may be based on FDM.

At 1032, after the communication signals 1012 are transmitted or after the first device 1002 determines to stop the transmission of the communication signals 1012, the first device 1002 may transmit a phase continuity reset indication 1014 (e.g., a second phase continuity reset indication) to the second device 1004 to inform the second device 1004 regarding a potential/possible phase continuity interruption and/or the transmission of the sensing signals 1008 is to be switched back to the first Tx beam. Similarly, at 1034, in response to the phase continuity reset indication 1014, the second device 1004 may again reset its Doppler frequency measurement.

At 1036, the first device 1002 may resume transmitting the sensing signals 1008 periodically via the first Tx beam (e.g., from slots 7 to N).

In one example, the first device 1002 may transmit the phase continuity reset indication 1010 and the phase continuity reset indication 1014 via downlink control information (DCI). In another example, the first device 1002 may transmit the phase continuity reset indication 1010 and the phase continuity reset indication 1014 with a cyclic redundancy check (CRC) scrambled with a dedicated radio network temporary identifier (RNTI) to one UE or by a group RNTI to a group of UEs.

In another aspect of the present disclosure, as transmitting sensing signals 1008 with communication signals 1012 based on FDM may reduce the maximum transmission power of the sensing signals 1008 (e.g., sensing signal in slots 5 and 6 may have lower transmission power than other slots), the first device 1002 may further transmit a transmission power change indication to the second device 1004 informing the second device 1004 regarding the reduction in transmission power at slots 5 and 6. In some examples, the first device 1002 may include the transmission power change indication in the phase continuity reset indication 1010 and/or the phase continuity reset indication 1014. Then, in response to the transmission power change indication, the second device 1004 may modify or adopt a more proper sensing measurement, such as by modifying the receiving power/gain.

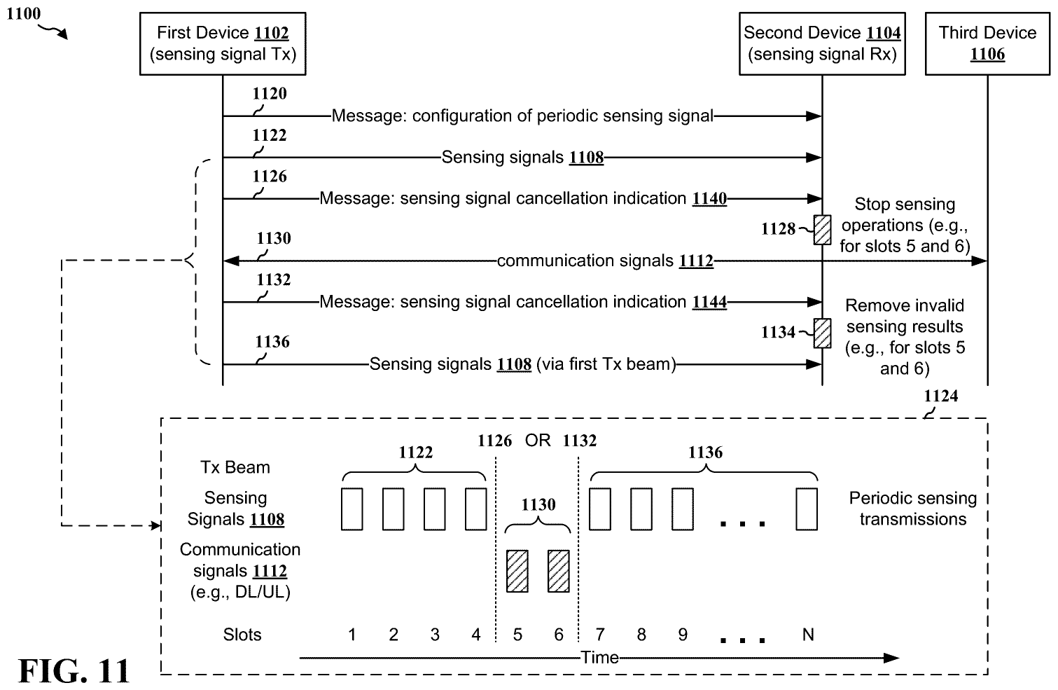

FIG. 11 is a communication flow 1100 illustrating an example of informing a sensing device regarding sensing signal cancellation during a bi-static/multi-static sensing operation in accordance with various aspects of the present disclosure. The numberings associated with the communication flow 1100 do not specify a particular temporal order and are merely used as references for the communication flow 1100. Aspects presented herein may enable a first device, such as a first base station, to transmit a sensing signal cancellation indication to a second device (e.g., a second base station or a sensing UE) when one or more configured sensing resources are overwritten/preempted by communication signals (e.g., URLLC communication signals or signals with higher transmission priorities) and there are not enough resources for transmitting sensing signals and communication signals concurrently on some transmission occasions.

At 1120, a first device 1102 (or a first apparatus or an antenna panel) may configure a second device 1104 to receive sensing signals 1108 periodically from the first device 1102. In one example, the first device 1102 may be a base station or a component of a base station, and the second device 1104 may be a UE, another base station or a component of another base station, etc. The sensing signals may be based on FMCW signals, such as described in connection with FIG. 5.

At 1122, after configuring the second device 1104 to receive the sensing signals 1108, the first device 1122 may transmit sensing signals 1108 for reception by the second device 1104 (or towards a target and for reception by the second device 1104). For example, as shown at 1124, the first device 1102 may transmit sensing signals 1108 periodically from a first slot (slot 1) to an N^{th} slot (slot N).

During transmission of the sensing signals 1108, the first device 1102 may be configured or scheduled to transmit or receive a set of communication signals 1112 (e.g., URLLC signals or UL/DL signals with higher priorities), such as to or from a third device 1106 and/or the second device 1104. For example, as shown at 1126, the first device 1102 may be scheduled to transmit or receive communication signals 1112 at slots 5 and 6. If the first device 1102 determines that the communication signals 1112 cannot be transmitted/received concurrently with the sensing signals 1108 (e.g., at slots 5 and 6), the first device 1102 may transmit a sensing signal cancellation indication to the second device 1104 informing the second device 1104 that one or more sensing signals may be cancelled (e.g., not be transmitted).

In one example, as shown at 1126, the first device 1102 may transmit a sensing signal cancellation indication 1140 prior to transmitting/receiving the communication signals 1112, where the sensing signal cancellation indication 1140 may indicate the number of following cancelled sensing signal occasions (e.g., two occasions after slot 4, sensing occasions at slots 5 and 6, etc.). In response, at 1128, the second device 1104 may stop the sensing operations for the indicated number of occasions after receiving the sensing signal cancellation indication 1140. For example, the second device 1104 may stop the sensing operations at slots 5 and 6. Then, at 1130, the first device 1102 may transmit/receive the communication signals 1112 to or from the second device 1104 and/or the third device 1106.

In another example, as shown at 1132, the first device 1102 may transmit a sensing signal cancellation indication 1144 after transmitting/receiving the communication signals 1112, where the sensing signal cancellation indication 1144 may indicate the number of previous canceled sensing signal occasions (e.g., two occasions prior to slot 7, sensing occasions at slots 5 and 6, etc.). In response, at 1134, the second device 1104 may remove the sensing result (e.g., invalid sensing result) for the indicated number of occasions after receiving the sensing signal cancellation indication 1144. For example, the second device 1104 may remove the sensing results obtained at slots 5 and 6. Then, at 1136, the first device 1102 may resume transmitting the sensing signals 1108 (e.g., from slots 7 to N).

In one example, the first device 1102 may transmit the sensing signal cancellation indication 1140/1144 via downlink control information (DCI). In another example, the first device 1102 may transmit the sensing signal cancellation indication 1140/1144 with an CRC scrambled with a dedicated RNTI to one UE or by a group RNTI to a group of UEs.

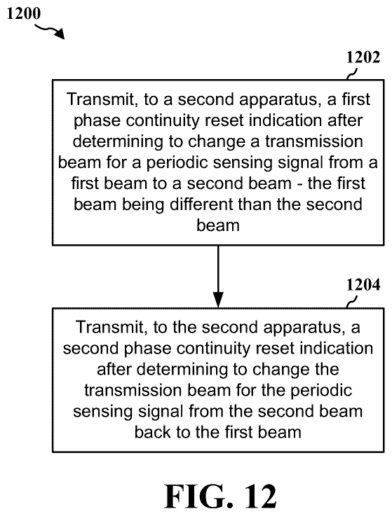

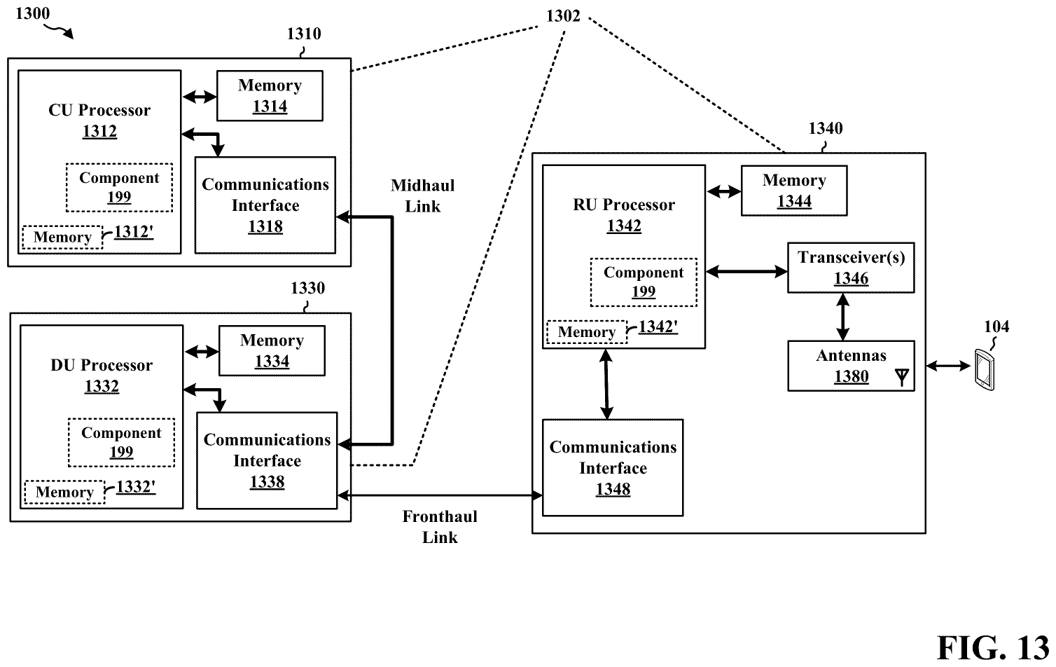

FIG. 12 is a flowchart 1200 of a method of wireless communication. The method may be performed by a first apparatus (e.g., the base station 102, 902; the first device 1002; the network entity 1302). At 1202, the first apparatus may transmit, to a second apparatus, a first phase continuity reset indication after determining to change a transmission beam for a periodic sensing signal from a first beam to a second beam, the first beam being different than the second beam, such as described in connection with FIG. 10. For example, at 1026, the first device 1002 may transmit the phase continuity reset indication 1010 to the second device 1004 after determining to change a transmission beam for the periodic sensing signal 1008 from the first Tx beam to the second Tx beam, where the first beam is different from the second beam. The transmission of the phase continuity reset indication may be performed by, e.g., the sensing-communication configuration component 199 and/or the transceiver(s) 1346 of the network entity 1302 in FIG. 13.

In one example, the first apparatus may transmit the sensing signal periodically to the second apparatus through the first beam before transmitting the first phase continuity reset indication. In such an example, the first apparatus may configure the second apparatus to receive the sensing signal periodically from the first apparatus, the configuration being before the transmission of the sensing signal periodically to the second apparatus.

In another example, the first apparatus may transmit concurrently the sensing signal to the second apparatus and a communication signal to a third apparatus through the second beam after transmitting the first phase continuity reset indication. In such an example, the sensing signal and the communication signal may be FDM within the second beam. In such an example, the first apparatus may determine to stop the transmission of the communication signal to the third apparatus, where the second phase continuity reset indication may be transmitted based on the determination to stop the transmission of the communication signal to the third apparatus.

At 1204, the first apparatus may transmit, to the second apparatus, a second phase continuity reset indication after determining to change the transmission beam for the periodic sensing signal from the second beam back to the first beam, such as described in connection with FIG. 10. For example, at 1032, the first device 1002 may transmit the phase continuity reset indication 1014 to the second device 1004 after determining to change the transmission beam for the periodic sensing signal 1008 from the second Tx beam back to the first Tx beam. The transmission of the phase continuity reset indication may be performed by, e.g., the sensing-communication configuration component 199 and/or the transceiver(s) 1346 of the network entity 1302 in FIG. 13.

In one example, the first apparatus may transmit the sensing signal periodically to the second apparatus through the first beam after transmitting the second phase continuity reset indication.

In another example, the first phase continuity reset indication and the second phase continuity reset indication may be transmitted through DCI.

In another example, the first phase continuity reset indication and the second phase continuity reset indication may be transmitted with a CRC scrambled based on an RNTI.

In another example, the first phase continuity reset indication may be transmitted concurrently with an indication that a transmit power for the sensing signal is being changed.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the sensing-communication configuration component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the sensing-communication configuration component 199 is configured to transmit, to a second apparatus, a first phase continuity reset indication after determining to change a transmission beam for a periodic sensing signal from a first beam to a second beam, the first beam being different than the second beam; and transmit, to the second apparatus, a second phase continuity reset indication after determining to change the transmission beam for the periodic sensing signal from the second beam back to the first beam. The sensing-communication configuration component 199 may be within one or more processors of one or more of the CU 1310, DU 1330, and the RU 1340. The sensing-communication configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting, to a second apparatus, a first phase continuity reset indication after determining to change a transmission beam for a periodic sensing signal from a first beam to a second beam, the first beam being different than the second beam; and means for transmitting, to the second apparatus, a second phase continuity reset indication after determining to change the transmission beam for the periodic sensing signal from the second beam back to the first beam.

In one configuration, the network entity 1302 further includes means for transmitting the sensing signal periodically to the second apparatus through the first beam before transmitting the first phase continuity reset indication.

In another configuration, the network entity 1302 further includes means for configuring the second apparatus to receive the sensing signal periodically from the first apparatus, the configuration being before the transmission of the sensing signal periodically to the second apparatus.

In another configuration, the network entity 1302 further includes means for transmitting concurrently the sensing signal to the second apparatus and a communication signal to a third apparatus through the second beam after transmitting the first phase continuity reset indication. In such a configuration, the sensing signal and the communication signal are FDMed within the second beam. In such a configuration, the network entity 1302 further includes means for determining to stop the transmission of the communication signal to the third apparatus, where the second phase continuity reset indication is transmitted based on the determination to stop the transmission of the communication signal to the third apparatus.

In another configuration, the network entity 1302 further includes means for transmitting the sensing signal periodically to the second apparatus through the first beam after transmitting the second phase continuity reset indication.

In another configuration, the first phase continuity reset indication and the second phase continuity reset indication are transmitted through DCI.

In another configuration, the first phase continuity reset indication and the second phase continuity reset indication are transmitted with a CRC scrambled based on an RNTI.

The means may be the sensing-communication configuration component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

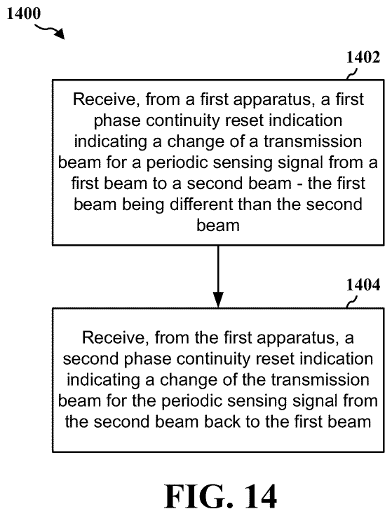

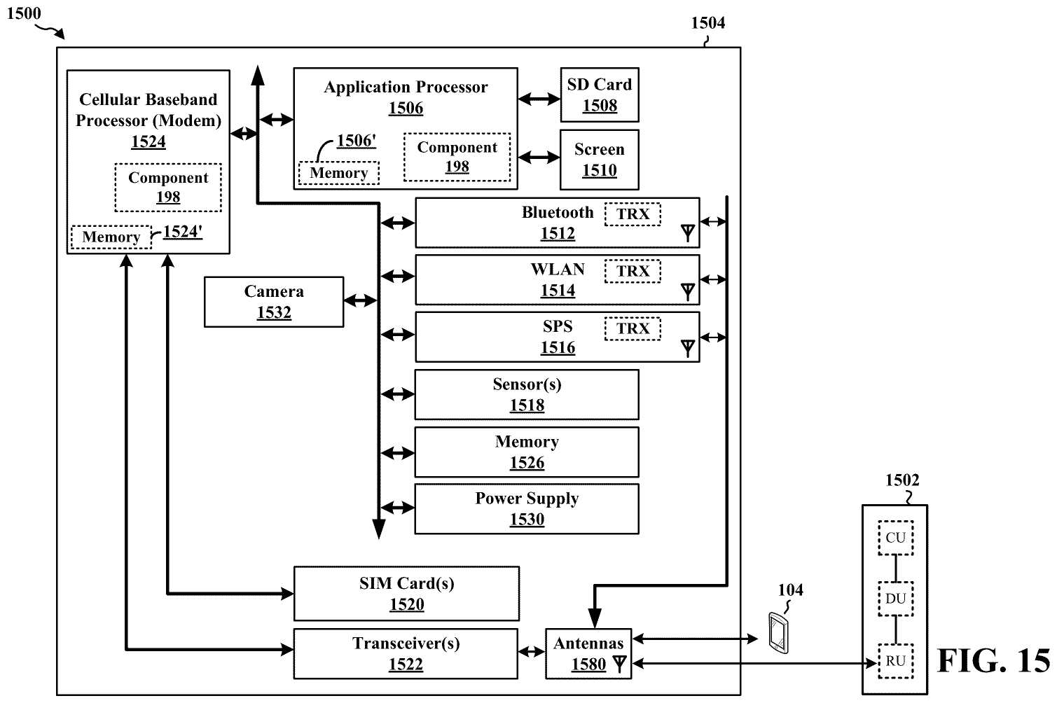

FIG. 14 is a flowchart 1400 of a method of wireless communication. The method may be performed by a second apparatus (e.g., the UE 104; the sensing UE 906; the second device 1004; the apparatus 1504). At 1402, the second apparatus may receive, from a first apparatus, a first phase continuity reset indication indicating a change of a transmission beam for a periodic sensing signal from a first beam to a second beam, the first beam being different than the second beam, such as described in connection with FIG. 10. For example, at 1026, the second device 1004 may receive the phase continuity reset indication 1010 from the first device 1002, where the first beam is different from the second beam. The reception of the phase continuity reset indication may be performed by, e.g., the sensing signal process component 198 and/or the transceiver(s) 1522 of the apparatus 1504 in FIG. 15.

In one example, the second apparatus may receive the sensing signal periodically from the first apparatus through the first beam before receiving the first phase continuity reset indication. In such an example, the second apparatus may receive a configuration from the first apparatus to receive the sensing signal periodically from the first apparatus, the configuration being before the reception of the sensing signal periodically from the first apparatus.

In another example, the second apparatus may receive the sensing signal from the first apparatus through the second beam after receiving the first phase continuity reset indication.

At 1404, the second apparatus may receive, from the first apparatus, a second phase continuity reset indication indicating a change of the transmission beam for the periodic sensing signal from the second beam back to the first beam, such as described in connection with FIG. 10. For example, at 1032, the second device 1004 may receive the phase continuity reset indication 1014 from the first device 1002. The reception of the phase continuity reset indication may be performed by, e.g., the sensing signal process component 198 and/or the transceiver(s) 1522 of the apparatus 1504 in FIG. 15.

In one example, the second apparatus may receive the sensing signal periodically from the first apparatus through the first beam after receiving the second phase continuity reset indication.

In another example, the first phase continuity reset indication and the second phase continuity reset indication may be received through DCI.

In another example, the first phase continuity reset indication and the second phase continuity reset indication may be received with a CRC scrambled based on an RNTI.

In another example, the first phase continuity reset indication may be received concurrently with an indication that a transmit power for the sensing signal is being changed by the first apparatus.

In another example, the second apparatus may reset a Doppler frequency measurement associated with the sensing signal upon receiving at least one of the first phase continuity reset indication or the second phase continuity reset indication.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the sensing signal process component 198 is configured to receive, from a first apparatus, a first phase continuity reset indication indicating a change of a transmission beam for a periodic sensing signal from a first beam to a second beam, the first beam being different than the second beam; and receive, from the first apparatus, a second phase continuity reset indication indicating a change of the transmission beam for the periodic sensing signal from the second beam back to the first beam. The sensing signal process component 198 may be within the cellular baseband processor 1524, the application processor 1506, or both the cellular baseband processor 1524 and the application processor 1506. The sensing signal process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for receiving, from a first apparatus, a first phase continuity reset indication indicating a change of a transmission beam for a periodic sensing signal from a first beam to a second beam, the first beam being different than the second beam; and means for receiving, from the first apparatus, a second phase continuity reset indication indicating a change of the transmission beam for the periodic sensing signal from the second beam back to the first beam.

In another configuration, the apparatus 1504 further includes means for receiving the sensing signal periodically from the first apparatus through the first beam before receiving the first phase continuity reset indication. In such a configuration, the apparatus 1504 further includes means for receiving a configuration from the first apparatus to receive the sensing signal periodically from the first apparatus, the configuration being before the reception of the sensing signal periodically from the first apparatus.

In another configuration, the apparatus 1504 further includes means for receiving the sensing signal from the first apparatus through the second beam after receiving the first phase continuity reset indication.

In another configuration, the apparatus 1504 further includes means for receiving the sensing signal periodically from the first apparatus through the first beam after receiving the second phase continuity reset indication.

In another configuration, the first phase continuity reset indication and the second phase continuity reset indication are received through DCI.

In another configuration, the first phase continuity reset indication and the second phase continuity reset indication are received with a CRC scrambled based on an RNTI.

In another configuration, the first phase continuity reset indication is received concurrently with an indication that a transmit power for the sensing signal is being changed by the first apparatus.

In another configuration, the apparatus 1504 further includes means for resetting a Doppler frequency measurement associated with the sensing signal upon receiving at least one of the first phase continuity reset indication or the second phase continuity reset indication.

The means may be the sensing signal process component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

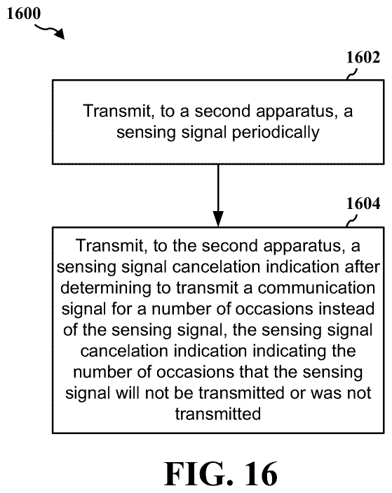

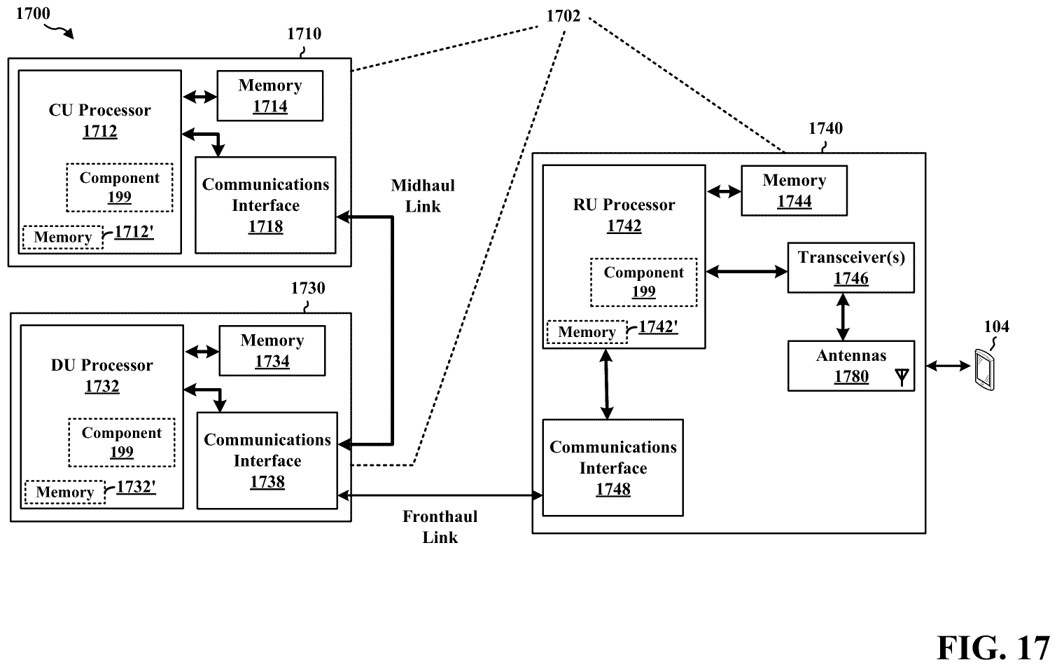

FIG. 16 is a flowchart 1600 of a method of wireless communication. The method may be performed by a first apparatus (e.g., the base station 102, 902; the first device 1102; the network entity 1702). At 1602, the first apparatus may transmit, to a second apparatus, a sensing signal periodically, such as described in connection with FIG. 11. For example, at 1112, the first device 1102 may transmit sensing signals 1108 to the second device 1104 periodically. The transmission of the sensing signal may be performed by, e.g., the sensing-communication configuration component 199 and/or the transceiver(s) 1746 of the network entity 1702 in FIG. 17.

At 1604, the first apparatus may transmit, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted, such as described in connection with FIG. 11. For example, at 1126 or 1132, the first device 1102 may transmit the sensing signal cancellation indication 1140 or the sensing signal cancellation indication 1144 to the second device 1104 indicating the number of occasions that the sensing signal will not be transmitted or was not transmitted. The transmission of the sensing signal cancellation indication may be performed by, e.g., the sensing-communication configuration component 199 and/or the transceiver(s) 1746 of the network entity 1702 in FIG. 17.

In one example, the first apparatus may transmit the communication signal to a third apparatus after transmitting the sensing signal cancelation indication, the sensing signal cancelation indication indicating the number of following occasions that the sensing signal will not be transmitted.

In another example, the first apparatus may transmit the communication signal to a third apparatus before transmitting the sensing signal cancelation indication, the sensing signal cancelation indication indicating the number of previous occasions that the sensing signal was not transmitted.

In another example, the first apparatus may transmit, to the second apparatus, the sensing signal periodically after the number of occasions.

In another example, the sensing signal cancelation indication may be transmitted through DCI.

In another example, the sensing signal cancelation indication may be transmitted with a CRC scrambled based on an RNTI.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the sensing-communication configuration component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the sensing-communication configuration component 199 is configured to transmit, to a second apparatus, a sensing signal periodically; and transmit, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted. The sensing-communication configuration component 199 may be within one or more processors of one or more of the CU 1710, DU 1730, and the RU 1740. The sensing-communication configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting, to a second apparatus, a sensing signal periodically; and means for transmitting, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted.

In another configuration, the network entity 1702 further includes means for transmitting the communication signal to a third apparatus after transmitting the sensing signal cancelation indication, the sensing signal cancelation indication indicating the number of following occasions that the sensing signal will not be transmitted.

In another configuration, the network entity 1702 further includes means for transmitting the communication signal to a third apparatus before transmitting the sensing signal cancelation indication, the sensing signal cancelation indication indicating the number of previous occasions that the sensing signal was not transmitted.

In another configuration, the network entity 1702 further includes means for transmitting, to the second apparatus, the sensing signal periodically after the number of occasions.

In another configuration, the sensing signal cancelation indication is transmitted through DCI.

In another configuration, the sensing signal cancelation indication is transmitted with a CRC scrambled based on an RNTI.

The means may be the sensing-communication configuration component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

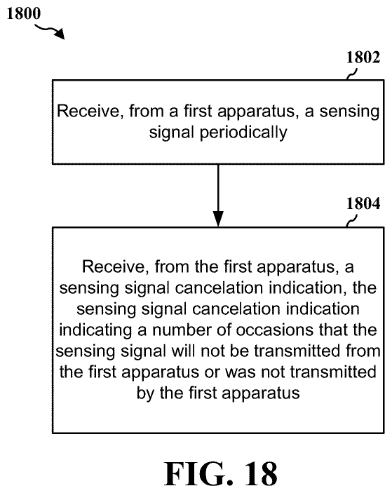

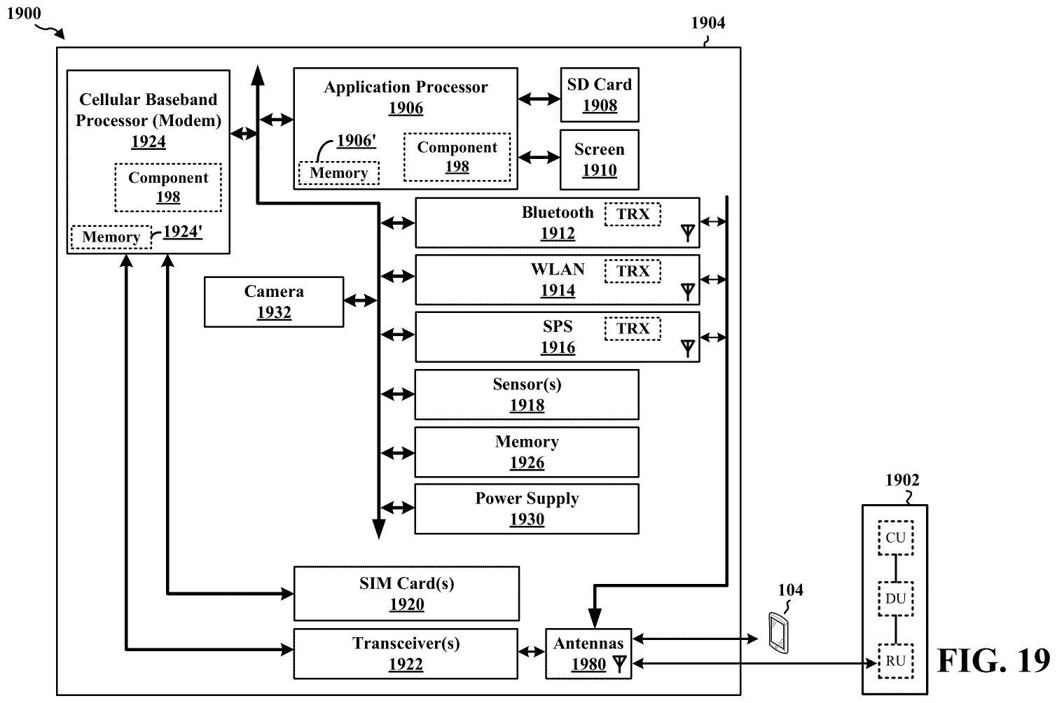

FIG. 18 is a flowchart 1800 of a method of wireless communication. The method may be performed by a second apparatus (e.g., the UE 104; the sensing UE 906; the second device 1104; the apparatus 1904). At 1802, the second apparatus may receiving, from a first apparatus, a sensing signal periodically, such as described in connection with FIG. 11. For example, at 1112, the second device 1104 may receive sensing signals 1108 from the first device 1102 periodically. The reception of the sensing signal may be performed by, e.g., the sensing signal process component 198 and/or the transceiver(s) 1922 of the apparatus 1904 in FIG. 19.

At 1804, the second apparatus may receive, from the first apparatus, a sensing signal cancelation indication, the sensing signal cancelation indication indicating a number of occasions that the sensing signal will not be transmitted from the first apparatus or was not transmitted by the first apparatus, such as described in connection with FIG. 11. For example, at 1126 or 1132, the second device 1104 may receive the sensing signal cancellation indication 1140 or the sensing signal cancellation indication 1144 from the first device 1102 indicating the number of occasions that the sensing signal will not be transmitted or was not transmitted. The reception of the sensing signal cancellation indication may be performed by, e.g., the sensing signal process component 198 and/or the transceiver(s) 1922 of the apparatus 1904 in FIG. 19.

In one example, the sensing signal cancelation indication may indicate the number of following occasions that the sensing signal will not be transmitted, and the second apparatus may stop from receiving the sensing signal for the indicated number of following occasions.

In another example, the sensing signal cancelation indication may indicate the number of previous occasions that the sensing signal was not transmitted, and the second apparatus may remove a sensing result for the sensing signal for the number of previous occasions based on the received sensing signal cancelation indication.

In another example, the second apparatus may receive, from the first apparatus, the sensing signal periodically after the number of occasions.

In another example, the sensing signal cancelation indication is received through DCI.

In another example, the sensing signal cancelation indication is received with a CRC scrambled based on a RNTI.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the sensing signal process component 198 is configured to receive, from a first apparatus, a sensing signal periodically; and receive, from the first apparatus, a sensing signal cancelation indication, the sensing signal cancelation indication indicating a number of occasions that the sensing signal will not be transmitted from the first apparatus or was not transmitted by the first apparatus. The sensing signal process component 198 may be within the cellular baseband processor 1924, the application processor 1906, or both the cellular baseband processor 1924 and the application processor 1906. The sensing signal process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for receiving, from a first apparatus, a sensing signal periodically; means for receiving, from the first apparatus, a sensing signal cancelation indication, the sensing signal cancelation indication indicating a number of occasions that the sensing signal will not be transmitted from the first apparatus or was not transmitted by the first apparatus; means for stopping from receiving the sensing signal for the indicated number of following occasions; means for removing a sensing result for the sensing signal for the number of previous occasions based on the received sensing signal cancelation indication; and means for receiving, from the first apparatus, the sensing signal periodically after the number of occasions. The means may be the sensing signal process component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first apparatus, including: transmitting, to a second apparatus, a first phase continuity reset indication after determining to change a transmission beam for a periodic sensing signal from a first beam to a second beam, the first beam being different than the second beam; and transmitting, to the second apparatus, a second phase continuity reset indication after determining to change the transmission beam for the periodic sensing signal from the second beam back to the first beam.
Aspect 2 is the method of aspect 1, further including transmitting the sensing signal periodically to the second apparatus through the first beam before transmitting the first phase continuity reset indication.
Aspect 3 is the method of aspect 2, further including configuring the second apparatus to receive the sensing signal periodically from the first apparatus, the configuration being before the transmission of the sensing signal periodically to the second apparatus.
Aspect 4 is the method of any of aspects 1 to 3, further including transmitting concurrently the sensing signal to the second apparatus and a communication signal to a third apparatus through the second beam after transmitting the first phase continuity reset indication.
Aspect 5 is the method of aspect 4, where the sensing signal and the communication signal are frequency division multiplexed within the second beam.
Aspect 6 is the method of aspect 4, further including determining to stop the transmission of the communication signal to the third apparatus, where the second phase continuity reset indication is transmitted based on the determination to stop the transmission of the communication signal to the third apparatus.
Aspect 7 is the method of any of aspects 1 to 6, further including transmitting the sensing signal periodically to the second apparatus through the first beam after transmitting the second phase continuity reset indication.
Aspect 8 is the method of any of aspects 1 to 7, where the first phase continuity reset indication and the second phase continuity reset indication are transmitted through DCI.
Aspect 9 is the method of any of aspects 1 to 8, where the first phase continuity reset indication and the second phase continuity reset indication are transmitted with a CRC scrambled based on an RNTI.
Aspect 10 is the method of any of aspects 1 to 9, where the first phase continuity reset indication is transmitted concurrently with an indication that a transmit power for the sensing signal is being changed.
Aspect 11 is an apparatus for wireless communication for implementing any of aspects 1 to 10.
Aspect 12 is an apparatus for wireless communication including means for implementing any of aspects 1 to 10.
Aspect 13 is a computer-readable medium storing computer executable code, where the code when executed by a processor causes the processor to implement any of aspects 1 to 10.
Aspect 14 is a method of wireless communication at a second apparatus, including: receiving, from a first apparatus, a first phase continuity reset indication indicating a change of a transmission beam for a periodic sensing signal from a first beam to a second beam, the first beam being different than the second beam; and receiving, from the first apparatus, a second phase continuity reset indication indicating a change of the transmission beam for the periodic sensing signal from the second beam back to the first beam.
Aspect 15 is the method of aspect 14, further including receiving the sensing signal periodically from the first apparatus through the first beam before receiving the first phase continuity reset indication.
Aspect 16 is the method of any of aspect 14, further including receiving a configuration from the first apparatus to receive the sensing signal periodically from the first apparatus, the configuration being before the reception of the sensing signal periodically from the first apparatus.
Aspect 17 is the method of any of aspects 14 to 16, further including receiving the sensing signal from the first apparatus through the second beam after receiving the first phase continuity reset indication.
Aspect 18 is the method of any of aspects 14 to 17, further including receiving the sensing signal periodically from the first apparatus through the first beam after receiving the second phase continuity reset indication.
Aspect 19 is the method of any of aspects 14 to 18, where the first phase continuity reset indication and the second phase continuity reset indication are received through DCI.
Aspect 20 is the method of any of aspects 14 to 19, where the first phase continuity reset indication and the second phase continuity reset indication are received with a CRC scrambled based on an RNTI.
Aspect 21 is the method of any of aspects 14 to 20, where the first phase continuity reset indication is received concurrently with an indication that a transmit power for the sensing signal is being changed by the first apparatus.
Aspect 22 is the method of any of aspects 14 to 21, further including resetting a Doppler frequency measurement associated with the sensing signal upon receiving at least one of the first phase continuity reset indication or the second phase continuity reset indication.
Aspect 23 is an apparatus for wireless communication for implementing any of aspects 14 to 22.
Aspect 24 is an apparatus for wireless communication including means for implementing any of aspects 14 to 22.
Aspect 25 is a computer-readable medium storing computer executable code, where the code when executed by a processor causes the processor to implement any of aspects 14 to 22.
Aspect 26 is a method of wireless communication at a first apparatus, including: transmitting, to a second apparatus, a sensing signal periodically; and transmitting, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted.
Aspect 27 is the method of aspect 26, further including transmitting the communication signal to a third apparatus after transmitting the sensing signal cancelation indication, the sensing signal cancelation indication indicating the number of following occasions that the sensing signal will not be transmitted.
Aspect 28 is the method of any of aspects 26 and 27, further including transmitting the communication signal to a third apparatus before transmitting the sensing signal cancelation indication, the sensing signal cancelation indication indicating the number of previous occasions that the sensing signal was not transmitted.
Aspect 29 is the method of any of aspects 26 to 28, further including transmitting, to the second apparatus, the sensing signal periodically after the number of occasions.
Aspect 30 is the method of any of aspects 26 to 29, where the sensing signal cancelation indication is transmitted through DCI.
Aspect 31 is the method of any of aspects 26 to 27, where the sensing signal cancelation indication is transmitted with a CRC scrambled based on an RNTI.
Aspect 32 is an apparatus for wireless communication for implementing any of aspects 26 to 31.
Aspect 33 is an apparatus for wireless communication including means for implementing any of aspects 26 to 31.
Aspect 34 is a computer-readable medium storing computer executable code, where the code when executed by a processor causes the processor to implement any of aspects 26 to 31.
Aspect 35 is a method of wireless communication at a first apparatus, including: receiving, from a first apparatus, a sensing signal periodically; and receiving, from the first apparatus, a sensing signal cancelation indication, the sensing signal cancelation indication indicating a number of occasions that the sensing signal will not be transmitted from the first apparatus or was not transmitted by the first apparatus.
Aspect 36 is the method of aspect 35, where the sensing signal cancelation indication indicates the number of following occasions that the sensing signal will not be transmitted, the method further including stopping from receiving the sensing signal for the indicated number of following occasions.
Aspect 37 is the method of any of aspects 35 and 36, where the sensing signal cancelation indication indicates the number of previous occasions that the sensing signal was not transmitted, the method further including removing a sensing result for the sensing signal for the number of previous occasions based on the received sensing signal cancelation indication.
Aspect 38 is the method of any of aspects 35 to 37, further including receiving, from the first apparatus, the sensing signal periodically after the number of occasions.
Aspect 39 is the method of any of aspects 35 to 38, where the sensing signal cancelation indication is received through DCI.
Aspect 40 is the method of any of aspects 35 to 39, where the sensing signal cancelation indication is received with a CRC scrambled based on an RNTI.
Aspect 41 is an apparatus for wireless communication for implementing any of aspects 35 to 40.
Aspect 42 is an apparatus for wireless communication including means for implementing any of aspects 35 to 40.
Aspect 34 is a computer-readable medium storing computer executable code, where the code when executed by a processor causes the processor to implement any of aspects 35 to 40.

What is claimed is:

1. An apparatus for wireless communication at a first apparatus, comprising:
a memory; and
at least one processor coupled to the memory and, based at least in part on information stored in the memory, the at least one processor is configured to:
transmit, to a second apparatus, a first phase continuity reset indication after determining to change a transmission beam for a periodic sensing signal from a first beam to a second beam, the first beam being different than the second beam; and
transmit, to the second apparatus, a second phase continuity reset indication after determining to change the transmission beam for the periodic sensing signal from the second beam back to the first beam.

2. The apparatus of claim 1, wherein the at least one processor is further configured to transmit the sensing signal periodically to the second apparatus through the first beam before transmitting the first phase continuity reset indication.

3. The apparatus of claim 2, wherein the at least one processor is further configured to configure the second apparatus to receive the sensing signal periodically from the first apparatus, the configuration being before the transmission of the sensing signal periodically to the second apparatus.

4. The apparatus of claim 1, wherein the at least one processor is further configured to transmit concurrently the sensing signal to the second apparatus and a communication signal to a third apparatus through the second beam after transmitting the first phase continuity reset indication.

5. The apparatus of claim 4, wherein the sensing signal and the communication signal are frequency division multiplexed (FDM) within the second beam.

6. The apparatus of claim 4, wherein the at least one processor is further configured to determine to stop the transmission of the communication signal to the third apparatus, wherein the second phase continuity reset indication is transmitted based on the determination to stop the transmission of the communication signal to the third apparatus.

7. The apparatus of claim 1, wherein the at least one processor is further configured to transmit the sensing signal periodically to the second apparatus through the first beam after transmitting the second phase continuity reset indication.

8. The apparatus of claim 1, wherein the first phase continuity reset indication and the second phase continuity reset indication are transmitted through downlink control information (DCI).

9. The apparatus of claim 1, wherein the first phase continuity reset indication and the second phase continuity reset indication are transmitted with a cyclic redundancy check (CRC) scrambled based on a radio network temporary identifier (RNTI).

10. The apparatus of claim 1, wherein the first phase continuity reset indication is transmitted concurrently with an indication that a transmit power for the sensing signal is being changed.

11. An apparatus for wireless communication at a second apparatus, comprising:
a memory; and
at least one processor coupled to the memory and, based at least in part on information stored in the memory, the at least one processor is configured to:
receive, from a first apparatus, a first phase continuity reset indication indicating a change of a transmission beam for a periodic sensing signal from a first beam to a second beam, the first beam being different than the second beam; and
receive, from the first apparatus, a second phase continuity reset indication indicating a change of the transmission beam for the periodic sensing signal from the second beam back to the first beam.

12. The apparatus of claim 11, wherein the at least one processor is further configured to receive the sensing signal periodically from the first apparatus through the first beam before receiving the first phase continuity reset indication.

13. The apparatus of claim 12, wherein the at least one processor is further configured to receive a configuration from the first apparatus to receive the sensing signal periodically from the first apparatus, the configuration being before the reception of the sensing signal periodically from the first apparatus.

14. The apparatus of claim 11, wherein the at least one processor is further configured to receive the sensing signal from the first apparatus through the second beam after receiving the first phase continuity reset indication.

15. The apparatus of claim 11, wherein the at least one processor is further configured to receive the sensing signal periodically from the first apparatus through the first beam after receiving the second phase continuity reset indication.

16. The apparatus of claim 11, wherein the first phase continuity reset indication and the second phase continuity reset indication are received through downlink control information (DCI).

17. The apparatus of claim 11, wherein the first phase continuity reset indication and the second phase continuity reset indication are received with a cyclic redundancy check (CRC) scrambled based on a radio network temporary identifier (RNTI).

18. The apparatus of claim 11, wherein the first phase continuity reset indication is received concurrently with an indication that a transmit power for the sensing signal is being changed by the first apparatus.

19. The apparatus of claim 11, wherein the at least one processor is further configured to reset a Doppler frequency measurement associated with the sensing signal upon receiving at least one of the first phase continuity reset indication or the second phase continuity reset indication.

20. An apparatus for wireless communication at a first apparatus, comprising:
a memory; and
at least one processor coupled to the memory and, based at least in part on information stored in the memory, the at least one processor is configured to:
transmit, to a second apparatus, a sensing signal periodically; and
transmit, to the second apparatus, a sensing signal cancelation indication after determining to transmit a communication signal for a number of occasions instead of the sensing signal, the sensing signal cancelation indication indicating the number of occasions that the sensing signal will not be transmitted or was not transmitted.

21. The apparatus of claim 20, wherein the at least one processor is further configured to transmit the communication signal to a third apparatus after transmitting the sensing signal cancelation indication, the sensing signal cancelation indication indicating the number of following occasions that the sensing signal will not be transmitted.

22. The apparatus of claim 20, wherein the at least one processor is further configured to transmit the communication signal to a third apparatus before transmitting the sensing signal cancelation indication, the sensing signal cancelation indication indicating the number of previous occasions that the sensing signal was not transmitted.

23. The apparatus of claim 20, wherein the at least one processor is further configured to transmit, to the second apparatus, the sensing signal periodically after the number of occasions.

24. The apparatus of claim 20, wherein the sensing signal cancelation indication is transmitted through downlink control information (DCI).

25. The apparatus of claim 20, wherein the sensing signal cancelation indication is transmitted with a cyclic redundancy check (CRC) scrambled based on a radio network temporary identifier (RNTI).

26. An apparatus for wireless communication at a second apparatus, comprising:
a memory; and
at least one processor coupled to the memory and, based at least in part on information stored in the memory, the at least one processor is configured to:
receive, from a first apparatus, a sensing signal periodically; and
receive, from the first apparatus, a sensing signal cancelation indication, the sensing signal cancelation indication indicating a number of occasions that the sensing signal will not be transmitted from the first apparatus or was not transmitted by the first apparatus.

27. The apparatus of claim 26, wherein the sensing signal cancelation indication indicates the number of following occasions that the sensing signal will not be transmitted, the at least one processor is further configured to stop from receiving the sensing signal for the indicated number of following occasions.

28. The apparatus of claim 26, wherein the sensing signal cancelation indication indicates the number of previous occasions that the sensing signal was not transmitted, the at least one processor is further configured to remove a sensing result for the sensing signal for the number of previous occasions based on the received sensing signal cancelation indication.

29. The apparatus of claim 26, wherein the at least one processor is further configured to receive, from the first apparatus, the sensing signal periodically after the number of occasions.

30. The apparatus of claim 26, wherein the sensing signal cancelation indication is received through downlink control information (DCI) or with a cyclic redundancy check (CRC) scrambled based on a radio network temporary identifier (RNTI).
